(19) United States
(12) Patent Application Publication
(10) Pub. No.: US 2024/0051854 A1
(43) Pub. Date: Feb. 15, 2024

(54) Electroreductive and Regenerative System

(71) Applicant: ACLARITY, INC, Mansfield, MA (US)

(72) Inventor: Orren David Schneider, Plainsboro, NJ (US)

(21) Appl. No.: 18/448,142

(22) Filed: Aug. 10, 2023

Related U.S. Application Data
(60) Provisional application No. 63/396,919, filed on Aug. 10, 2022.

(51) Int. Cl. C02F 1/467; B01J 49/30; C02F 1/461; B01J 41/05; C02F 1/28

(52) U.S. Cl. CPC C02F 1/4676; B01J 49/30; C02F 1/46109; B01J 41/05; C02F 1/28; C02F 2001/46133; C02F 2201/46135; C02F 2101/14

(57) ABSTRACT

An electroreductive and regenerative system includes an electrochemical reduction reactor having a housing and a reactor inlet. A cathode and an anode are disposed at least partially within a fluid flow-path. A spent ion-exchange resin slurry delivery inlet is fluidly connected to the reactor inlet. The spent ion-exchange resin slurry delivery inlet is connected to a source of spent ion-exchange slurry. A method of concurrently electroreductively remediating poly- and perfluorinated alkyl substances (PFAS) and regenerating an ion-exchange resin material includes providing an electrolyte-containing spent ion-exchange resin slurry, the spent ion-exchange resin slurry comprising a plurality of PFAS molecules immobilized on a surface of an ion-exchange resin material in the electrolyte containing spent ion-exchange resin slurry, and directing the electrolyte-containing, spent ion-exchange resin slurry through an electrochemical reduction reactor to remediate PFAS and form regenerated ion-exchange resin material in a regenerated ion-exchange material slurry.

### CROSS REFERENCE TO RELATED APPLICATIONS

This application claims the benefit under 35 U.S.C. § 119(e) of U.S. provisional application Ser. No. 63/396,919, filed on Aug. 10, 2022, the entire disclosure of which is hereby incorporated by reference.

### FIELD OF THE DISCLOSURE

The disclosure relates generally to liquid purification devices and more specifically to an electroreductive and regenerative system for destroying poly- and perfluorinated alkyl substances (PFAS) contaminants in a liquid and for regenerating ion exchange resins.

### BACKGROUND

Poly- and perfluorinated alkyl substances (PFAS) are a ubiquitous and persistent class of anthropogenic environmental pollutants. PFAS have valuable properties and are often found in many consumer products, such as non-stick or waterproof surfaces, which are used in furniture, carpets, paper products, cookware, textiles, and cosmetics, among other products. However, PFAS are also potentially harmful to humans and animals. Some studies have shown that PFAS can cause damage to the liver and to the immune system, as well as cause birth defects, delayed development and newborn deaths. Additionally, PFAS can undesirably linger in the environment and decay very slowly. Consequently, PFAS are often referred to as “forever chemicals.”

PFAS molecules comprise a hydrophobic tail (including a backbone of single-bonded carbon atoms and fluorine atoms bound to the carbon backbone) and a hydrophilic head group (typically including a carboxylic acid or sulfonic acid). These head groups are negatively charged over a wide pH range and can therefore bind with positively charged sites on anion exchange resins. Currently, PFAS is typically removed from the environment, such as from groundwater, by using sorbents (such as granular activated carbon (“GAC”)) or ion exchange resins to capture the PFAS compounds. Once the sorbent or ion-exchange resin is saturated with PFAS, these materials are generally transferred to another location for disposal, most often by incineration.

The primary mechanisms of PFAS removal using ion exchange resins are electrostatic interactions and, depending on the specific resin, some hydrophobic effects, whereas GAC adsorption relies almost exclusively on hydrophobic interactions (such that higher hydrophobicity and molecular weight PFAS are increasingly amenable to GAC adsorption).

While sorbents, such as GAC, are typically effective at removing longer chain PFAS, they are not as effective at removing shorter chain PFAS. On the other hand, ion exchange resins are effective at removing both long and short chain PFAS. Because shorter chain PFAS species are becoming more prevalent, ion exchange resins are generally becoming widely used to address the broader spectrum of PFAS molecules.

Ion-exchange resins can be prepared in the form of granules, beads, or sheets. When immersed in a solution, ion-exchange resins absorb ions from solution and swell. The resins commonly include a styrene-divinylbenzene copolymer, although other copolymers, such as methacrylic acid-divinylbenzene and phenol-formaldehyde polymers, are also used. There are two broad categories of ion exchange resins: cationic and anionic. The negatively charged cationic exchange resins (CER) are effective for removing positively-charged contaminants and positively charged anion exchange resins (AER) are effective for removing negatively charged contaminants, like PFAS. The electrically charged ionic groups are commonly sulfonic or carboxylic acid salts (CER) or quaternary ammonium salts (AER).

Negatively charged ions of PFAS are attracted to the positively charged anion exchange resins. Anion exchange resins work by having multiple cationic functional groups present on the surface of the resin. In the anion exchange resin, this cationic charge is initially balanced by the presence of an exchangeable/displaceable anion (typically, chloride). When a PFAS molecule approaches the exchange site, an anionic head group on the PFAS molecule (generally, either a sulfonate or carboxylate group) has a greater affinity for the cationic functional group and effectively displaces and replaces the chloride, thus capturing the PFAS molecule on the resin surface, thereby immobilizing the PFAS molecule. The displaced chloride ion enters the water stream and passes into the effluent.

While AER typically have a high capacity for many PFAS, AER is typically more expensive than granular activated carbon (GAC). Furthermore, AER resins used in practice today are usually single use; and even less desirable, the single-use resins are typically incinerated to ultimately dispose of the captured PFAS.

While regenerable AERs are also available, upon regeneration, a waste brine with a high concentration of PFAS must be treated, for example, by concentration and/or incineration, prior to disposal. The additional regeneration and disposal requirements have caused single-use resins to be more economical and more widely adopted in practice. Moreover, single-use resins typically have a much higher removal capacity.

Further, such existing PFAS removal technologies do not destroy PFAS, they merely transfer them to another medium.

### SUMMARY OF THE DISCLOSURE

According to one example, an electroreductive and regenerative system includes an electrochemical reduction reactor having a housing and a reactor inlet. The housing includes an internal fluid flow-path and a reactor outlet. A cathode and an anode are disposed at least partially within the fluid flow-path. The cathode has an outer, reducing, reactive surface disposed within the internal fluid flow-path. The anode has an outer, oxidizing, reactive surface disposed within the internal fluid flow-path. At least portions of the anode outer, oxidizing, reactive surface and the cathode outer, reducing, reactive surface are separated by an electroactive gap. The internal fluid flow-path comprises the electroactive gap. A power supply is electrically connected to the anode and to the cathode such that electrons flow from the anode to the cathode. A spent ion-exchange resin slurry delivery inlet is fluidly connected to the electrochemical reduction reactor. The spent ion-exchange resin slurry delivery inlet is connected to a source of spent ion-exchange slurry. An electrolyte inlet can be fluidly connected to the electrochemical reduction reactor. The electrolyte inlet can also be fluidly connected to a source of electrolyte. A solid liquid separator can be located downstream of the reactor outlet. When present, the solid liquid separator can be configured to capture solid particles of regenerated ion exchange resin material that exit the reactor outlet.

The foregoing example of an electroreductive and regenerative system may further include any one or more of the following optional features, structures, and/or forms.

In some optional forms, a voltage regulator is electrically coupled to the power supply and the voltage regulator controls voltage of the power supply.

In other optional forms, a slurry container is fluidly connected to the spent ion-exchange resin slurry delivery inlet as the source of spent ion-exchange slurry. The slurry container contains a spent ion-exchange resin slurry comprising spent ion-exchange resin material dispersed in a solvent.

In other optional forms, an adsorbent is fluidly connected to, and downstream of, the reactor outlet. Typically, the adsorbent is downstream of the filter, if present. The adsorbent is configured to remove fluoride ions.

In other optional forms, the adsorbent comprises activated alumina.

In some optional forms, the source of electrolyte comprises a salt chosen from one or more in the group of NaCl, NaOH, KCl, KOH, Na₂SO₄, K₂SO₄, NH₄Cl, (NH₄)₂SO₄, and NH₄OH. The electrolyte may further comprise methanol, ethanol, propanol, or other alcohols.

In other optional forms, the oxidizing, reactive, outer surface of the anode is elemental titanium metal and the reducing, reactive, outer surface of the cathode is elemental titanium metal, Magneli-phase titanium oxide (e.g., Ti₄O₇), boron doped diamond, or mixed metal oxides.

In other optional forms, the electrochemical reduction reactor and/or reactor inlet is fluidly connected to a source of oxidant scavenger.

In other optional forms, the oxidant scavenger comprises a reduced sulfur compound. The oxidant scavenger may be chosen from one or more reduced sulfur compounds in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid. Other reduced sulfur compounds and other known oxidant scavengers such as reduced iron compounds may also be used.

In other optional forms, a source of spent ion-exchange resin material is operatively connected to the slurry container, the source of spent ion exchange resin material including an anion exchange resin capable of removing PFAS.

In other optional forms, the anode comprises a hollow cylinder coaxially located with the cathode, which is cylindrically-shaped, such that a longitudinal axis of the anode and a longitudinal axis of the cathode are substantially co-linear.

According to another example, a method of concurrently electroreductively remediating poly- and perfluorinated alkyl substances (PFAS) and regenerating an ion-exchange resin material includes providing an electrolyte-containing spent ion-exchange resin slurry, the spent ion-exchange resin slurry comprising a plurality of PFAS molecules immobilized on a surface of an ion-exchange resin material in the electrolyte containing spent ion-exchange resin slurry, and directing the electrolyte-containing, spent ion-exchange resin slurry through an electrochemical reduction reactor to remediate PFAS and form regenerated ion-exchange resin material in a regenerated ion-exchange material slurry.

The foregoing example of a method of concurrently electroreductively remediating PFAS and regenerating ion exchange resin material may further include any one or more of the following optional features, structures, and/or forms.

In some optional forms, the electrolyte-containing spent ion-exchange resin slurry is formed by dispersing the spent ion-exchange resin material in an aqueous solvent.

In yet other optional forms, the electrolyte-containing spent ion-exchange resin slurry is further formed by adding an electrolyte to the aqueous solvent.

In yet other optional forms, solid particles of the regenerated ion exchange resin material are captured from the regenerated ion exchange resin slurry.

In other optional forms, liquid remaining after optional removal of the solid particles of regenerated ion exchange resin material is passed through an activated alumina bed or column to capture liberated fluoride ions (that are produced by the electrochemical degradation of PFAS).

In other optional forms, the electrolyte includes a salt chosen from one or more salts in the group of NaCl, NaOH, Na₂SO₄, K₂SO₄, KCl, KOH, NH₄Cl, (NH₄)₂SO₄, and NH₄OH. The electrolyte may further comprise methanol, ethanol, propanol, or other alcohols.

In other optional forms, the electrolyte-containing spent ion exchange resin slurry includes the spent ion-exchange resin material in an amount of greater than about 0.5 weight percent (wt. %), based on the weight of the electrolyte-containing spent ion exchange resin slurry. In yet other optional forms, the electrolyte-containing spent ion exchange resin slurry includes the spent ion-exchange resin material an amount of less than about 10 wt. %, based on the weight of the electrolyte-containing spent ion exchange resin slurry.

In other optional forms, an anode of the electrochemical reduction reactor comprises a material chosen from one or more in the group of elemental titanium metal and Magneli-phase titanium oxide.

In other optional forms, a cathode of the electrochemical reduction reactor comprises a material chosen from one or more in the group of elemental titanium metal, Magneli-phase titanium oxide, boron doped diamond, and a mixed metal oxide.

In other optional forms, an oxidant scavenger is added to the electrochemical reduction reactor or upstream of the electrochemical reduction reactor.

In other optional forms, the oxidant scavenger comprises a reduced sulfur compound. The oxidant scavenger may be chosen from one or more reduced sulfur compounds in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid. Other reduced sulfur compounds and other known oxidant scavengers such as reduced iron compounds may also be used.

In other optional forms, the liberated fluoride ions (produced by the electrochemical degradation of PFAS) are advantageously captured and disposed of thereby regenerating the electrolyte.

In other optional forms, chloride ions from the electrolyte displaces the carboxylate or sulfonate headgroup on the ion-exchange resin to regenerate the ion-exchange resin.

In other optional forms, the ion-exchange resin material comprises a strong base anion-exchange resin, for example, such as Type I anion exchange resin or a Type II ion exchange resin.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a schematic drawing of an electroreductive and regenerative system.

FIG. 2 is an exploded perspective view of an electrochemical reduction reactor that may be used in the electroreductive and regenerative system of FIG. 1.

FIG. 3 is a side view of the electrochemical reduction reactor of FIG. 2.

FIG. 4 is side cross-sectional view of the electrochemical reduction reactor of FIG. 2.

FIG. 5 is a close-up side cross-sectional view of an inlet cap of the electrochemical reduction reactor of FIG. 2.

FIG. 6 is a close-up side cross-sectional view of an outlet cap of the electrochemical reduction reactor of FIG. 2.

FIGS. 7A and 7B are top and cross-sectional schematic views, respectively, of an alternate embodiment of an electrochemical reduction reactor that may be used in the electroreductive and regenerative system of FIG. 1.

FIGS. 8A and 8B are top and cross-sectional schematic views, respectively, of yet another alternate embodiment of an electrochemical reduction reactor that may be used in the electroreductive and regenerative system of FIG. 1.

### DETAILED DESCRIPTION

The electroreductive and regenerative systems and methods described herein are advantageously used for treatment of spent ion-exchange resin, particularly spent anion-exchange resin for capturing PFAS that is saturated with PFAS. Advantageously, the electroreductive and regenerative systems and methods described herein can remediate poly- and perfluorinated alkyl substances (PFAS) while concurrently regenerating an anion-exchange resin material that previously was saturated with PFAS molecules. Further, this technology can be advantageously retrofitted into many existing commercial, industrial, and municipal water treatment facilities without significant modifications thereof. As such, any additional transport to a separate facility for further processing (e.g., incineration) as well as incineration of the spent ion-exchange resin can be beneficially eliminated by incorporating the disclosed electroreductive and regenerative systems into the water-treatment facility.

Electroreductive and regenerative systems disclosed herein include electrochemical reduction reactors that work on their intended target contaminants by causing oxidation reactions to occur at the anode and/or chemical reduction reactions to occur at the cathode. These redox reactions are intrinsically linked to one another in that each electron essentially flows from the anode oxidizing, reactive, outer surface to the opposing cathode reducing, reactive, outer surface. Said another way, for each substance that is reduced, another substance must be oxidized, said oxidized substance potentially creating, in situ, in the electrochemical reactor, oxidants capable of reacting with any reduced species including reduced species that can reform the oxidized substances that are intended to be (successfully) treated, remediated, and/or destroyed. Typically, both oxidation and reduction reactions are considered to be desirable, or at least innocuous, in electrochemical reactors as both oxidation and reduction reactions can facilitate degradation of target contaminants. The inventors have surprisingly and advantageously found that minimizing, reducing, and/or otherwise controlling oxidation reactions, particularly oxidant levels attributable to oxidation reactions occurring at an outer, oxidizing, reactive surface of the anode, within the electrochemical reduction reactors, is particularly important for regeneration of the spent ion-exchange resin because oxidants can damage the ion-exchange resin material.

The electroreductive and regenerative systems described herein are durable and scalable to meet relatively small demands as well as relatively large consumer, commercial, municipal or industrial demands. Advantageously, the electroreductive and regenerative systems described herein have few moving parts and therefore have long useful lives, while being relatively inexpensive and easy to manufacture. Moreover, the electroreductive and regenerative systems described herein surprisingly and unexpectedly can more efficiently treat ion-exchange resins saturated with contaminants, particularly anion exchange resins saturated with PFAS, with significantly less waste being produced and with a simplicity of operation, particularly relative to existing treatment/disposal methods involving incineration or disposal in RCRA or CERCLA landfills. Moreover, the electroreductive and regenerative systems described herein can advantageously regenerate spent ion-exchange material for reuse as ion-exchange materials including exchangeable/displaceable ions, thereby reducing waste and costs and increasing efficiency of treating or removing contaminants, for example, PFAS. In general, the resin-electrolyte slurry is recirculated through the system multiple times until the PFAS is destroyed and the resin regenerated by the presence of the electrolyte at which time the resin is removed from the system.

As used herein, the term “electrochemical reduction reactor” refers to a reactor in which the working electrode is the cathode. Said another way, the contaminants to be treated are reduced at the cathode rather than oxidized at the anode.

As used herein, an electrochemical reduction reactor refers to a reactor having a solution or fluid flow-path there through. The basic structural elements of an electrochemical reduction reactor include a housing having an inlet, an outlet, one or more anodes, and one or more cathodes generally arranged in an opposing relationship to the anode(s), as described and shown for example in US Patent Publication No. 2019/0284066, and in U.S. Patent Publication No. 2022/0073380, each of which are hereby incorporated by reference in their entirety. The reactors disclosed in US Patent Publication Nos. 2019/0284066 and U.S. Patent Publication No. 2022/0073380 are structured and arranged for oxidation of target contaminants. While the current flow in the electrochemical reactor exemplified in US Patent Publication No. 2019/0284066 and U.S. Patent Publication No. 2022/0073380 can be reversed, such that the electrochemical reactor is rearranged to effect reduction of contaminant species, the present inventors surprisingly found that, for some contaminants, such as PFAS, such operation was found to be undesirable and/or substantially inoperable, as the overall reduction efficiency was poor, as measured, for example, by a percentage of reduced species to PFAS, or that for some electrodes, e.g., stainless steel, significant corrosion of the materials occurred which increases resistance and negatively impacts the rate of reaction at the electrodes. Further, the electrons produced at the anodes of these reactors are not expected to have enough energy to break carbon-fluorine bonds and thus are not expected to be effective for degrading/destroying PFAS molecules.

The disclosed electroreductive and regenerative systems utilize electrons to treat spent ion-exchange materials comprising a plurality of PFAS molecules immobilized on a surface of the ion-exchange resin material. Specifically, without intending to be bound by theory, it is believed that PFAS is brought into proximity with a cathode of the electrochemical reduction reactor where hydrated electrons can attack bonds in the PFAS molecule that are adjacent to the negatively charged sulfonate or carboxylate headgroup of the PFAS molecule, thereby separating the headgroup from the hydrophobic tail of the PFAS molecule, causing the tail to become relatively more hydrophobic and to more preferentially sorb to a surface of the cathode, where the body can be more readily degraded electrochemically. When the PFAS tail is on or near the cathode surface, the PFAS tail can be reduced which destroys the contaminants. Furthermore, in the absence of the hydrophobic electrostatic interaction between the PFAS tail and the ion exchange resin hydrophobic copolymer and/or resin cross-linkers, the remaining anionic head group of the PFAS molecule (generally either a sulfonate or carboxylate group) can be displaced/replaced with the original displaceable chloride anions of the AER, for example by washing with solutions comprising high concentrations of chloride. Finally, while the foregoing description refers to PFAS, this degradation mechanism and regeneration of the corresponding ion exchange resin is applicable to other negatively charged hydrophobic contaminants as well.

Further, the electrodes of the electrochemical reduction reactor that are employed in the disclosed electroreductive and regenerative systems are not consumed by the reactions, which drastically reduces the maintenance requirements as well as the cost of replacement. As a result, fouling or scaling of the electrodes by agglomeration of organic matter, or by precipitation of metals, can advantageously be reversed by reversing the polarity of the electrodes, backwashing with water, increasing voltage, or by cleaning with an acid or base. Furthermore, as previously described, the disclosed electroreductive and regenerative systems regenerate spent ion exchange material substantially concurrently while destroying PFAS. The system can be operated in semi-batch mode allowing recovery of discrete loads of resin and include an optional cleaning operation after resin recovery.

“About,” “approximately,” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about,” “approximately,” or “substantially” can mean within one standard deviation, or within ±10%, 5%, 3%, or 1% of the stated value.

“Carbonaceous” as used herein means a material that comprises carbon. To be considered “carbonaceous” as used herein, a material should contain carbon with carbon atoms in other than a +4 oxidation state (such that the carbon atoms are capable of being oxidized). For example, carbonaceous materials include, but are not limited to, graphite, graphene, fullerenes, electrically conductive plastics, and diamond.

In order for any electrochemical process (and thus for the disclosed electroreductive and regenerative systems) to operate, there must be two (or more) electrodes generally opposed to one another and functioning as an anode(s) and a cathode(s). “Electroactive gap” as used herein means a gap or space between the electrodes functioning as the anode(s) and the cathode(s). In the flow-through electrochemical reduction reactors used in the disclosed electroreductive and regenerative systems, the electroactive gap is provided in the flow-path through which the solution, typically an aqueous phase to be treated, may flow and electrons may be transferred when the electrodes of the electrochemical reactors are powered. The current flow can cause various chemical reactions, such as reducing reactions, to take place within the electroactive gap, that cause contaminants (or portions thereof) to be preferentially sorbed from the ion-exchange resins saturated with contaminants in the water/solution being treated to degrade and/or be rendered inactive, thereby rendering contaminants less harmful, regenerating the ion-exchange resin, and purifying the source water.

“Dimensionally stable anode” as used herein (and as conventionally understood) refers to an anode that displays relatively high conductivity and corrosion resistance. Generally, dimensionally stable anodes are manufactured from one or more metal oxides such as RuO₂ (ruthenium oxide), IrO₂ (iridium oxide), SnO (tin oxide) and/or PtO₂ (platinum oxide).

“Mixed metal oxide electrodes” as used herein (which may be used as the anode or as the cathode) are made by coating a substrate, such as a titanium plate or an expanded mesh, with a mixture of metal oxides. One of the oxides present is usually RuO₂ (ruthenium oxide), IrO₂ (iridium oxide), SnO (tin oxide) or PtO₂ (platinum oxide), for conducting electricity and catalyzing the desired reactions.

As used herein, the term “Magneli-phase titanium oxide” refers to a titanium oxide having general formula TiₙO₂ₙ₋₁, for example, Ti₄O₇, Ti₅O₉, Ti₆O₁₁, or a mixture thereof. In an embodiment, the Magneli-phase titanium oxide may be Ti₄O₇. In other embodiments, the Magneli-phase titanium oxide may be a mixture of Magneli-phase titanium oxides. In a preferred embodiment, a cathode comprises Ti₄O₇ and has an outer, reducing, reactive surface of exposed Ti₄O₇.

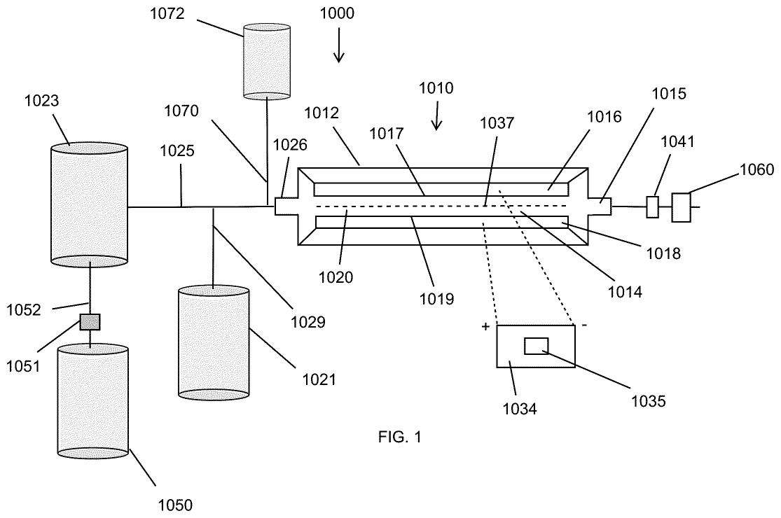

Turning now to FIG. 1, an electroreductive and regenerative system 1000 includes an electrochemical reduction reactor 1010 having a housing 1012 and a reactor inlet 1026. The housing includes an internal fluid flow-path 1014 and a reactor outlet 1015. A cathode 1016 and an anode 1018 are disposed at least partially within the fluid flow-path 1014 and generally oppose one another. The cathode 1016 has an outer, reducing, reactive surface 1017 disposed within the internal fluid flow-path 1014. The outer, reducing, reactive surface 1017 of the cathode 1016 may comprise Ti₄O₇ or elemental titanium metal. The anode 1018 has an outer, oxidizing, reactive surface 1019 disposed within the internal fluid flow-path 1014. The oxidizing, reactive, outer surface 1019 of the anode may comprise elemental titanium metal. When this specific selection of cathode and anode materials are combined and the anode 1018 and cathode 1016 are structured and arranged as disclosed, oxidant formation at the anode 1018 can surprisingly and advantageously be minimized. Advantageously, when combined and arranged as described, the oxidizing, reactive, outer surface 1019 of the anode 1018 does not create oxidant species, or minimizes creation of oxidant species (typically, chlorine gas, hypochlorous acid, and/or reactive oxygen species), which again can be disadvantageous because these oxidant species can irretrievably damage the ionic exchange resin, thereby precluding regeneration of an anionic exchange resin with displaceable anions, as will be discussed further below.

At least portions of the anode outer, oxidizing, reactive surface 1019 and the cathode outer, reducing, reactive surface 1017 are separated by an electroactive gap 1020 which generally corresponds to the distance between the electrodes 1016, 1018. The internal fluid flow-path 1014 comprises the electroactive gap 1020.

A power supply 1034 is electrically coupled to the anode 1018 and to the cathode 1016, such that electrons flow from the anode 1018 to the cathode 1016. An optional voltage regulator 1035 may be electrically coupled to the power supply 1034. The voltage regulator 1035 controls voltage of the power supply 1034 to minimize production of chlorine gas, hypochlorous acid, and/or reactive oxygen species at the anode 1018. The voltage regulator 1035 may be integrally formed with the power supply 1034, or the voltage regulator 1035 may be a separate element operationally connected to the power supply 1034. Generally, the inventors have found that the voltage regulator 1035 should operate the electrochemical reduction reactor at a voltage less than about 8.0 volts, preferably less than about 7.5 volts, for example, between about 1.0 volts and about 8.0 volts. In one preferred embodiment, the voltage can be set in a range between 1.20 volts and about 3.70 volts, for example, between about 1.80 volts and about 3.40 volts. Of course, the controlled voltage operation range can change based on numerous system parameters including but not limited to the specific electrodes, pH concentration, and the electrolyte concentration. At such a voltage, undesirable chlorine gas, hypochlorous acid, and reactive oxygen species formation at the anode can be minimized.

Turning back to FIG. 1, a spent ion-exchange resin slurry delivery inlet 1025 is fluidly connected to the reactor inlet 1026. The spent ion-exchange resin slurry delivery inlet 1025 is connected to a source of spent ion-exchange slurry disposed in a slurry container 1023. The slurry container 1023 is adapted to contain a spent ion-exchange slurry comprising spent ion-exchange resin material dispersed in a solvent. The solvent may further include an electrolyte dissolved therein.

In the illustrated embodiment, an electrolyte inlet 1029 fluidly is connected to the reactor inlet 1026. However, an electrolyte inlet need not be separate from the spent ion-exchange resin slurry delivery inlet 1025, for example, if the spent ion-exchange slurry already includes an electrolyte. The electrolyte inlet 1029 is also connected to a source of electrolyte 1021. The electrolyte may comprise a salt chosen from one or more in the group of NaCl, NaOH, Na₂SO₄, K₂SO₄, KCl, KOH, NH₄Cl, (NH₄)₂SO₄, and NH₄OH. The electrolyte may further comprise methanol, ethanol, propanol, or other alcohols. Ammonium salts are particularly beneficial when included in the electrolyte in that they can quickly react with any chlorine gas, hypochlorous acid, or reactive oxygen species generated in situ as a result of chloride oxidation or other oxidation processes at the anode. In embodiments, the electrolyte-containing spent ion exchange resin slurry includes the spent ion-exchange resin material in an amount of about 10% or less based on the weight of the electrolyte-containing spent ion exchange resin slurry. In yet other embodiments, the electrolyte-containing spent ion-exchange resin slurry includes the spent ion-exchange resin material in an amount of between about 0.5 wt. % and about 10 wt. % based on the weight of the electrolyte-containing spent ion exchange resin slurry.

Optionally, an ion exchange membrane 1037 may be disposed at least partially between the anode 1018 and the cathode 1016, within the internal fluid flow-path 1014. In some embodiments, the ion-exchange membrane 1037 comprises a cationic exchange membrane. The cationic exchange membrane allows cations to cross the membrane, but not anions, which prevents reoxidization of chemically reduced contaminants at the anode. The ion-exchange membrane 1037 is generally positioned to segregate any oxidant formed at the oxidizing, reactive, outer surface 1019 of the anode 1018, from the reducing, reactive, outer surface 1017 of the cathode 1016. Consequently, in addition from preventing any anions from crossing the membrane to be reoxidized at the anode, any oxidant formed at the anode advantageously does not cross the membrane and thus, does not interfere with reducing reactions occurring at or near the reducing, reactive, outer surface 1017 of the cathode 1016, let alone cause any structural damage to the ionic exchange resin being processed therein. By providing the ion exchange membrane 1037, typically formed oxidant species, including but not limited to chlorine, hypochlorous acid, and reactive oxygen species, which can otherwise react with and reoxidize (partially) chemically reduced species, can advantageously be segregated on one side of the ionic exchange membrane 1037 thereby effectively enhancing the overall conversion efficiency of the electrochemical reduction system 1000.

In the illustrated embodiment of FIG. 1, a solid liquid separator 1041 is located downstream of the reactor outlet 1015. The solid liquid separator 1021 is configured to capture solid particles of regenerated ion exchange resin material that exit the reactor outlet 1015. The solid liquid separator 1041 may comprise one or more separation technologies including centrifugation, decanter separation, disc stack separation, hydrocyclone separation, vibrating screen separation, filtration, and settling tank separation, to capture regenerated ion exchange resin material. In one embodiment, when used in a batch treatment mode, the solid liquid separator 1041 may comprise a conical settling tank where the solid resin particles are allowed to settle out of the liquid in a quiescent zone in the conical settling tank. Separated liquid from the conical settling tank may be returned and recycled for remediating and regenerating additional ion-exchange resin material in the electrochemical reactor.

As shown, an adsorbent 1060 is fluidly connected to, and downstream of, the solid liquid separator 1041. The adsorbent 1060 is configured to remove fluoride ions generated by the electrochemical degradation of PFAS from liquid exiting the solid liquid separator 1041. The adsorbent 1060 may comprise an activated alumina bed or column.

Again, in the illustrated embodiment, an oxidant scavenger inlet 1070 is fluidly connected to the reactor inlet 1026 and the oxidant scavenger inlet 1070 is connected to a source of oxidant scavenger 1072. Alternatively, an oxidant scavenger inlet need not be separate from the spent ion-exchange resin slurry delivery inlet 1025, for example, if the oxidant scavenger is added to the ion-exchange resin. Thus, the oxidant scavenger 1072 may be introduced directly into the reactor inlet 1026, into the internal fluid flow-path 1014, or upstream of the reactor inlet 1026. The source of oxidant scavenger 1072 may comprise a reduced sulfur compound. The oxidant scavenger may be chosen from one or more reduced sulfur compounds in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid. Other reduced sulfur compounds and other known oxidant scavengers such as reduced iron compounds may also be used.

A source of spent ion exchange resin material 1050 is operatively connected to the slurry container 1023 by a spent ion exchange resin material inlet 1052. The source of spent ion exchange resin material 1050 typically comprises an anion exchange resin capable of sorbing/removing PFAS from an aqueous liquid, for example a strong base anion exchange resin, for example, such as Type I anion exchange resin or a Type II ion exchange resin. Anion exchange resins such as Purolite® PFA694E, or ResinTech® SIR-110-HP may be used. Alternatively, the source of spent ion exchange resin material 1050 comprises a specialty ion-exchange resin formulated, functionalized, or derivatized for a specific contaminant such as PFAS. Specialty anion exchange resins such as Ambersorb® 560, Sorbix® Pure, or Sorbix®RePure may be used.

PFAS is electroreductively remediated concurrently with regenerating the ion-exchange resin material in the electroreductive and regenerative systems described above.

Generally, in the methods disclosed herein, PFAS is removed from a liquid stream by exposing the liquid stream to an anion exchange resin. As explained above, anion exchange resins work by having multiple cationic functional groups present on the surface of the resin. In the unused resin, this cationic charge is balanced by the presence of an anion (typically chloride). When a PFAS molecule approaches the exchange site, the anionic head group on the PFAS molecule (generally either a sulfonate or carboxylate group) displaces the chloride and is thus rendered immobile on the resin surface; the displaced chloride ion enters the water stream and passes into the column effluent. The displacement of the anion on the resin surface by the charged head group PFAS molecule produces a spent ion-exchange resin material.

In order to dispose of the PFAS molecules and regenerate the spent ion-exchange resin material, initially, the spent ion-exchange resin material is provided, for example, by the source of spent ion-exchange resin material 1050. The spent ion-exchange material is converted into a spent ion-exchange resin slurry, for example, by dispersing the spent ion-exchange resin material into an aqueous solvent, for example in the slurry container 1023. The spent ion-exchange resin slurry contains discrete beads or pieces of spent ion-exchange resin material mixed with the aqueous solvent.

The spent ion-exchange material may be moved from the source of spent ion-exchange material 1050 to the slurry container 1023 by a pump 1051. In the illustrated embodiment a single pump 1051 is illustrated between the source of spent-ion exchange material 1050 and the slurry container 1023. In other embodiments, the pump 1051 may be located in a different position, such as between the slurry container 1023 and the reactor inlet 1026. In yet other embodiments, multiple pumps 1051 may be used to move various inputs from sources to the reactor inlet 1026, for example, a pump may be located between the source of electrolyte 1021 and/or the source of oxidant scavenger 1072 and the reactor inlet 1026. Where the pump 1051 is moving any composition that contains beads of spent ion-exchange material (e.g., between the source of spent ion-exchange material 1050 and the slurry container 1023, or between the slurry container 1023 and the reactor inlet 1026), a pump type is preferred that will not mechanically harm the beads of spent ion-exchange material (e.g., by crushing or shredding). Thus, in a preferred aspect, the pump is not a centrifugal pump. One preferred type of pump is a positive displacement pump. A positive displacement pump moves a fluid by repeatedly enclosing a fixed volume and moving it mechanically through the system. The pumping action is cyclic and can be driven by pistons, screws, gears, rollers, diaphragms, or vanes.

Positive displacement pumps add energy to a fluid by applying force to the liquid with a mechanical device such as a piston or plunger. A positive displacement pump decreases the volume containing the liquid until the resulting liquid pressure equals the pressure in the discharge system. In the illustrated embodiment, the liquid containing the beads of spent ion-exchange material is compressed mechanically, causing a direct rise in potential energy and thus causing the liquid to flow. Some positive displacement pumps comprise reciprocating pumps in which the linear motion of a piston or plunger in a cylinder causes the displacement. Suitable positive displacement pumps include peristaltic pumps, diaphragm pumps, and progressing cavity pumps.

An optional electrolyte can be added to the aqueous solvent, for example, through direct addition to the slurry container or via the electrolyte inlet 1029, thereby forming an electrolyte-containing, spent ion-exchange resin slurry. The electrolyte is chosen from one or more in the group of NaCl, NaOH, Na₂SO₄, K₂SO₄, KCl, KOH, NH₄Cl, (NH₄)₂SO₄, NH₄OH, or combinations thereof. Ammonium salts are particularly beneficial when included in the electrolyte in that they can quickly react with any chlorine gas and/or hypochlorous acid generated in situ as a result of chloride oxidation at the anode. The electrolyte-containing spent ion exchange resin slurry includes the spent ion-exchange resin material in an amount of greater than about 0.5 wt. %, based on the weight of the electrolyte-containing spent ion exchange resin slurry. In embodiments, the electrolyte-containing spent ion exchange resin slurry includes the spent ion-exchange resin material in an amount of less than about 10 wt. %, based on the weight of the electrolyte-containing spent ion exchange resin slurry. In yet other embodiments, the electrolyte-containing spent ion-exchange resin slurry includes the spent ion-exchange resin material in an amount of between 0.5 wt. % and 10 wt. %, based on the weight of the electrolyte-containing spent ion exchange resin slurry.

When ion exchange resins are subjected to oxidants like chlorine gas, hypochlorous acid, or ozone, the cationic exchange site (typically an amine group) can be damaged, releasing the captured anion. This type of damage can render the resin unusable and/or less active in terms of sorption of a target contaminant such as PFAS. However, amine functional groups on the ion exchange resin are not damaged by strong reducing conditions and thus it is advantageous to use an electrochemical reduction reactor as described herein, particularly one that is adapted to further reduce, minimize, or even prevent oxidant formation in situ within the electrochemical reducing reactor.

In order to destroy the PFAS immobilized on the cationic exchange site, and to regenerate the ion-exchange resin, the electrolyte-containing, spent ion-exchange resin slurry is introduced into the electrochemical reduction reactor 1010 through the reactor inlet 1026. Within the electrochemical reduction reactor, PFAS is remediated (e.g., destroyed) and regenerated ion-exchange resin material is formed in a regenerated ion-exchange material slurry.

When the electrolyte-containing, spent ion exchange resin slurry is directed through the electrochemical reduction reactor 1010, one or more of the PFAS molecules in the plurality of PFAS molecules is brought into proximity with the outer, reducing, reactive surface 1017 of the cathode 1016, and without being limited by theory, it is theorized that hydrated electrons can attack bonds in the PFAS molecule that are adjacent to a sulfonate or carboxylate headgroup of the PFAS molecule. As a result, the charged headgroup can be separated from a hydrophobic body or tail of the PFAS molecule, thereby causing the body to become relatively more hydrophobic and thus more readily sorbed to a surface of the cathode 1016, where the body can be degraded electrochemically efficiently. Without the hydrophobic body, the hydrophilic headgroup may subsequently be readily displaced from the resin by anions (typically, chloride, sulfate, or hydroxide) in the electrochemically treated slurry, thereby regenerating the ion-exchange resin.

After exiting the electrochemical reduction reactor 1010, solid particles of the regenerated ion exchange resin material are captured from the regenerated ion exchange resin slurry by the solid liquid separator 1041. The resin can be captured, for example, by filters/screens, hydrocyclones, or by settling as described above.

The liquid remaining after removal of the solid particles of regenerated ion exchange resin material can be passed through the activated alumina bed or column 1060 to capture liberated fluoride ions that are produced from the electrochemical degradation of PFAS. The liberated fluoride ions are captured and disposed of, while chloride, hydroxide, or sulfate is then displaced into the effluent which can itself beneficially be recycled in the system as the electrolyte.

An optional oxidant scavenger 1072 may be added to the electrochemical reduction reactor 1010 or upstream of the electrochemical reduction reactor 1010. In other embodiments, the oxidant scavenger (e.g., ascorbic acid, reduced sulfur compounds, or others) may be fed into the electrochemical reduction reactor 1010 along with the spent ion-exchange resin slurry to eliminate, reduce, or mitigate any chlorine or other oxidants that may be formed at the anode to prevent, reduce, or mitigate damage to the integrity of the ion exchange resin. The oxidant scavenger may be a reduced sulfur compound or a reduced iron compound. The oxidant scavenger may be chosen from one or more reduced sulfur compounds in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid. Other reduced sulfur compounds and other known oxidant scavengers such as reduced iron compounds may also be used.

The spent ion-exchange resin material may comprise a strong base anion exchange resin, for example, such as Type I anion exchange resin or a Type II ion exchange resin. Anion exchange resins such as Purolite® PFA694E, or ResinTech® SIR-110-HP may be used. Alternatively, the source of spent ion exchange resin material 1050 comprises a specialty ion-exchange resin formulated functionalized, or derivatized for a specific contaminant such as PFAS. Specialty anion-exchange resins such as Ambersorb® 560, Sorbix® Pure, or Sorbix®RePure may be used.

In one example, the spent ion-exchange resin slurry may contain between 1 and 10 g/L of spent ion-exchange resin material and have a spent ion-exchange resin material content between 0.5 wt. % and 5 wt. %, based on the weight of the electrolyte-containing spent ion exchange resin slurry. The spent ion-exchange resin slurry is circulated through the electrochemical reduction reactor at a voltage <7.5V. After exiting the electrochemical reduction reactor, the regenerated ion-exchange material slurry is passed through the solid liquid separator 1041 to capture solid particles of the regenerated ion exchange resin material for reuse. The remaining liquid includes ions from making the slurry along with fluoride ions liberated from the PFAS. This liquid stream is passed through an activated alumina bed to capture the fluoride ions. The effluent containing chloride ions can be reused as electrolyte to facilitate treatment of a subsequent batch of spent ion-exchange resin material.

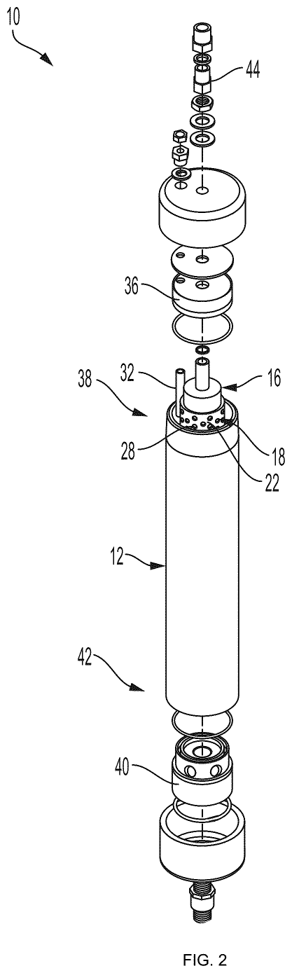

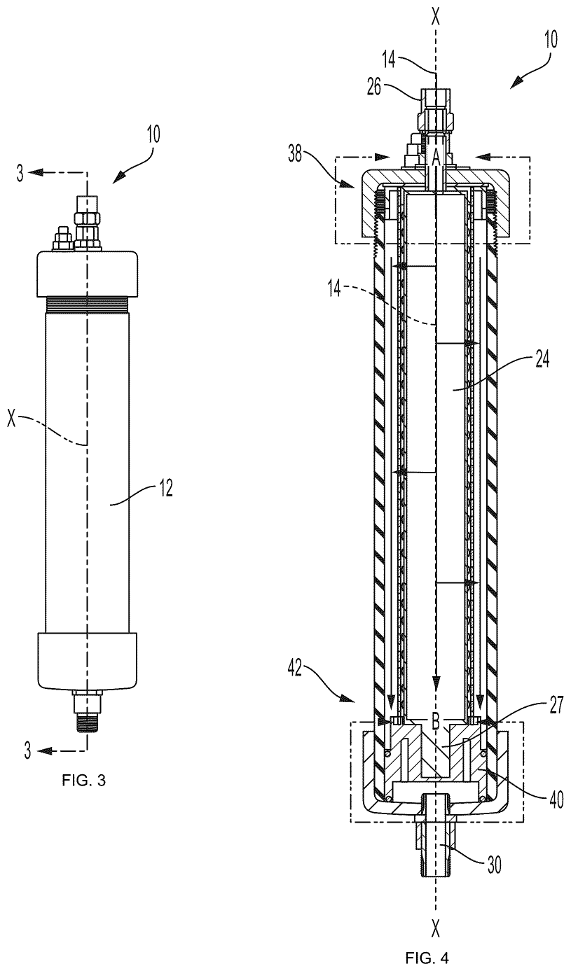

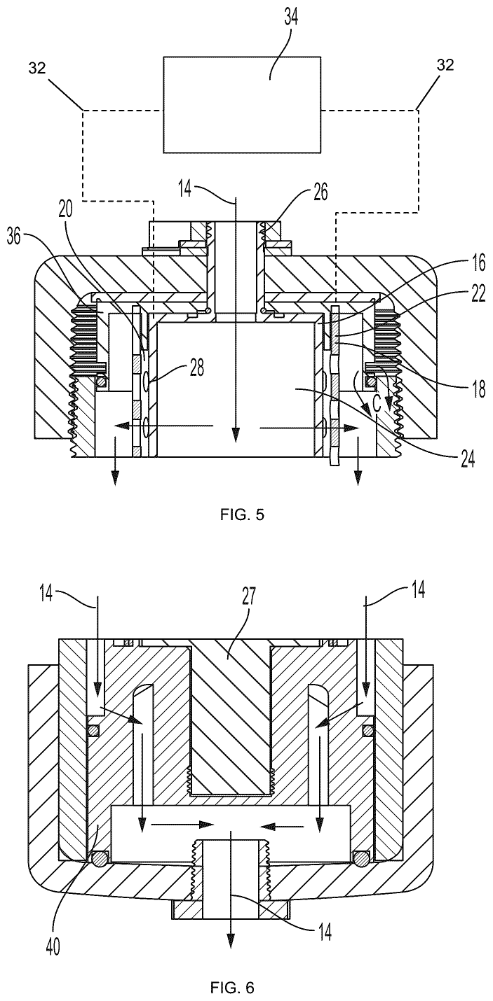

Turning now to FIGS. 2-6, an additional exemplary electrochemical reduction reactor 10 is illustrated that may be used in the electroreductive and regenerative system 1000 of FIG. 1 in lieu of or in combination with electrochemical reduction reactor 1010. Other examples of electrochemical reduction reactors described herein may also be used as alternatives in the electrochemical reduction system 1000 of FIG. 1.

Referring again to FIGS. 2-6, the illustrated electrochemical reduction reactor 10 includes a housing 12 having a fluid flow-path 14. A flow-through or solid first electrode, such as a cathode 16, is disposed within the fluid flow-path 14. In the illustrated embodiment, the cathode 16 is annulus-shaped and comprises a hollow cylinder, comprising a porous material or perforations or apertures. Such modified cathodes 16 can advantageously permit radial flow within the housing 12.

A second electrode, such as an anode 18, is spaced apart from the cathode 16, thereby creating an electroactive gap 20 between the anode 18 and the cathode 16. In some embodiments, the electroactive gap 1020 is less than 25 cm and greater than 1 cm. In other embodiments, the electroactive gap 20 is greater than about 1 mm and less than about 1 cm. For example, in some embodiments, the electroactive gap is greater than 2 mm and less than 5 mm, for example, about 3 mm. In the illustrated embodiment, the anode 18 is concentrically arranged about the cathode 16. In embodiments where the anode 18 or the cathode 16 comprise porous walls, the porous wall can be provided by a cylinder comprising a porous material (with pores at least two times larger than the spent ion-exchange material) or by a cylinder with perforations or apertures as shown in the illustrated embodiment. In both instances, radial flow through the anode 18 is possible. As mentioned above, the concentric arrangement of the anode 18 and the cathode 16 may also be reversed.

As illustrated in FIGS. 2-6, both the anode 18 and the cathode 16 have a hollow cylindrical shape. The anode 18 and the cathode 16 are arranged concentrically, the cathode 16 being located within a cylindrical wall 22 of the anode 18. The arrangement illustrated in FIGS. 2-6 is particularly useful as an electrochemical reduction reactor as described herein. In the illustrated embodiment of FIGS. 2-6, the concentrically arranged anode 18 and cathode 16 share a common longitudinal axis x. An interior 24 of the cathode 16 forms an initial flow-path for the water/solution to be treated that enters the housing 12 through an inlet 26. As the water/solution to be treated fills the interior 24, it flows longitudinally, parallel to the longitudinal axis x and eventually reaches the bottom of the interior 24 where the liquid is stopped by a plug 27. Once stopped, pressure builds up in the interior 24, which forces the liquid to flow radially outward, perpendicular to the longitudinal axis x, and over the wall of the cathode 16 such that it can now access the electroactive gap 20 between the anode 18 and the cathode 16. The liquid may pass through the wall of the anode 18 through porous openings in the anode 18, or through apertures or perforations in the anode 18, allowing treated fluid to be appropriately directed via an outlet 30.

A power source 34 is connected to the anode 18 and to the cathode 16 via an electrical connection 32. The power source 34 ultimately supplies DC power to the cathode 16 and to the anode 18. The power source 34 may directly supply DC power, or the power source 34 may convert AC power to DC, for example with a transformer rectifier, before supplying the cathode 16 and the anode 18. In use, the power source 34 charges the anode 18 and the cathode 16 and water/solution being treated fills the electroactive gap 20, such that electrons flow between the anode 18 and the cathode 16 and so as to drive certain desirable chemical reactions causing primarily chemical reduction of contaminants. The power source 34 may include, or be connected to, a voltage regulator (not shown in FIG. 2-6), as discussed above with respect to FIG. 1.

The inlet cap 36 is disposed at a first end 38 of the housing 12, the inlet cap 36 maintains proper spacing and orientation of the anode 18 relative to the cathode 16. An outlet guide flow cap 40 is disposed at a second end 42 of the housing 12. The outlet guide flow cap 40 seals the second end 42 of the housing 12 and receives outlet flow from the exterior of the cathode 16. The outlet guide flow cap 40 also seals one end of the interior 24 of cathode 16 in conjunction with the plug 27.

An adapter base inlet 44 is disposed at the first end 38 of the housing 12, the adapter base inlet 44 providing plumbing and electrical connections while maintaining a pressure seal.

The cathode 16 may comprise carbonaceous materials, stainless steel, elemental titanium, Magneli-phase titanium oxide (of general formula TiₙO₂ₙ₋₁, for example Ti₄O₇), mixed metal oxides (such as RuO2 (ruthenium oxide), IrO2 (iridium oxide), SnO (tin oxide) or PtO2 (platinum oxide)), or boron doped diamond (BDD), or a combination thereof. As used herein, the term “Magneli-phase titanium oxide” refers to a titanium oxide having general formula TiₙO₂ₙ₋₁, for example, Ti₄O₇, Ti₅O₉, Ti₆O₁₁, or a mixture thereof. In an embodiment, the Magneli-phase titanium oxide may be Ti₄O₇. In other embodiments, the Magneli-phase titanium oxide may be a mixture of Magneli-phase titanium oxides. In preferred embodiments, the cathode comprises elemental titanium or Ti₄O₇ and has an outer, reducing, reactive surface of exposed elemental titanium or Ti₄O₇.

The anode 18 may comprise one of elemental titanium metal, dimensionally stable anodes (DSA), Magneli-phase titanium oxide (of general formula TiₙO₂ₙ₋₁, for example Ti₄O₇), mixed metal oxides (such as RuO₂ (ruthenium oxide), IrO₂ (iridium oxide), SnO (tin oxide) or PtO₂ (platinum oxide)), boron doped diamond (BDD), others, or a combination thereof. In a preferred embodiment, the anode 18 comprises an oxidizing, reactive, outer surface of exposed elemental titanium. The anode may be in the form of a titanium mesh.

Once an appropriate electrochemical reduction reactor is constructed and arranged, the power is applied to the cathode(s) and the anode(s), and fluid to be treated is passed through the electrodes resulting in electrochemical reduction purification thereof. The regenerated ion exchange resin is subsequently removed/directed/collected from the outlet of the electrochemical reduction reactor. The applied power may be reversed periodically to prevent passivation of the electrodes and to remove foulants. In other embodiments, the reactor may be periodically backwashed to purge built up solids that may have accumulated in the reactor. The reactor may also be cleaned between batches using water to flush the system, acids or bases to remove metals and/or organic foulants on electrode or reactor surfaces, or other cleaning agents including surfactants or alcohols.

The electroreductive and regenerative system, according to any embodiment, may further optionally include an oxidation-reduction potential sensor, a pH sensor, a chlorine/total oxidant sensor, a conductivity sensor, a flow rate sensor, a pressure sensor, a temperature sensor, one or more contaminant sensors (such as nitrogen, TOC, UV-Vis, etc.), or a combination thereof.

Some advantages for using the disclosed electrochemical reduction reactors are high corrosion resistance to acidic and basic solutions, high electrical conductivity, increased mass transfer, long electrode life, and electrochemical stability. Other advantages include easily disposable byproducts of the reactions, and small and efficient electrochemical reduction reactor systems.

In use, water treatment includes providing an electrochemical reduction reactor, such as the electrochemical reduction reactor 10, 1010 described above. Power is supplied to the cathode 16 and to the anode 18 by a power supply 34, 1034, such that electrons flow from the cathode 16 to the anode 18. The voltage regulator 1035 is operably connected to the power supply 34, 1034. A slurry containing a spent ion exchange resin is passed through the electroactive gap 20, 1020. The PFAS or other negatively charged hydrophobic contaminant is chemically reduced at the cathode outer, reducing, reactive surface 1017. The voltage applied by the power supply 34, 1034 is controlled with the voltage regulator 1035.

Optionally, the oxidant scavenger 1021 is added to the fluid containing electrolyte-containing, spent ion exchange resin slurry to chemically reduce any oxidant formed at the anode outer, oxidizing, reactive surface 1019, but the oxidant scavenger 1021 can be introduced into the fluid flow-path of the electrochemical reduction reactor separately as well.

As the electrolyte-containing, spent ion exchange resin slurry flows through the electroactive gap 20, 1020, turbulence can be advantageously created by mixing, for example with one or more baffles, within the electroactive gap 20, 1020 which enhances mixing and chemical reduction of the PFAS molecules associated therewith at the cathode outer, reducing, reactive surface 1017.

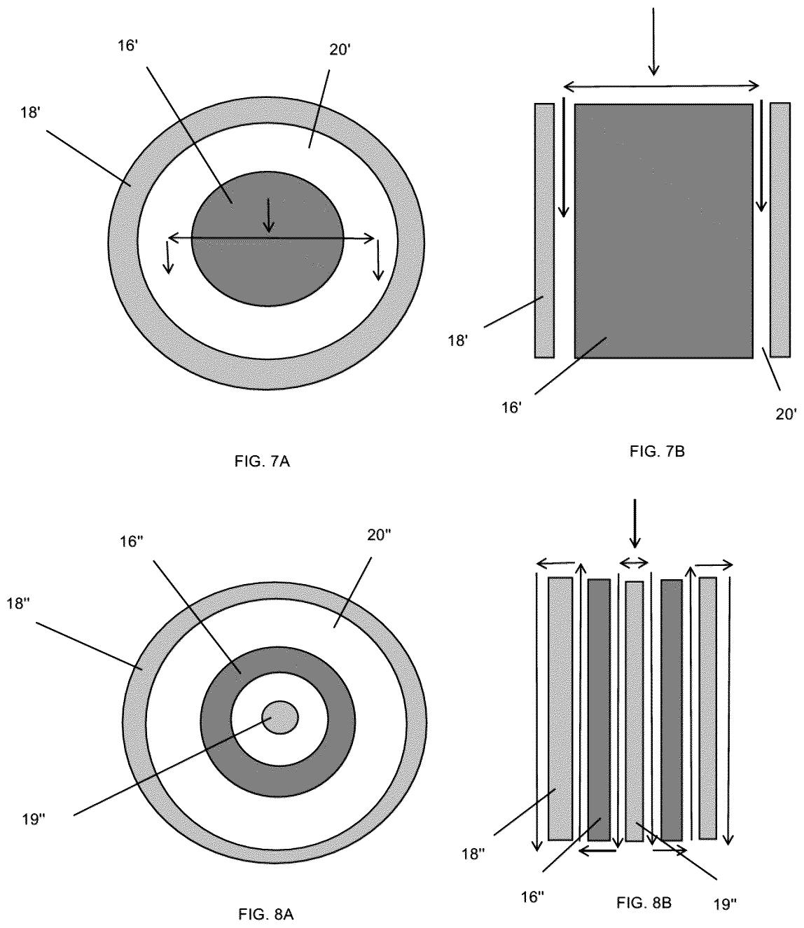

In other embodiments, for example as illustrated in FIGS. 7A and 7B, the cathode 16′ comprises a solid cylinder, as the liquid enters through the inlet (not shown in FIGS. 7A and 7B), the fluid flows (represented by arrows in FIGS. 7A and 7B) over an outer surface of the cathode cylinder 16′, thereby accessing the electroactive gap 20′ between the outer surface of the cathode 16′ and an inner surface of the anode 18′ proximate to the inlet. Thereafter, the liquid flows between the anode 18′ and the cathode 16′, through the electroactive gap 20′.

In yet other embodiments, for example as illustrated in FIGS. 8A and 8B, the cathode 16″ comprises a hollow cylinder with a solid wall, a first anode 18′ comprising a hollow cylinder with a solid wall is disposed concentrically and outside of the cathode 16 and a second anode 19″ is optionally disposed within the hollow annular space defined by the cathode 16″ solid wall. In this embodiment, the liquid can flow (represented by the arrows in FIGS. 8A and 8B) across the top of the second anode 19″, then downward, through the hollow annular space of the cathode 16″ between the solid cathode wall and the second anode 19″ until reaching a bottom of the interior, where the liquid is stopped and forced to flow laterally outwards around a bottom end of the solid cathode 16″ wall and then upwards between an outer surface of the solid cathode 16″ wall and an inner surface of the first anode 18″. Alternatively, this design can be used with a single flow-path similar to the one described in FIG. 7A, but allowing access to the electroactive gaps between cathode 16″ and anode 19″ as well as between cathode 16″ and anode 19″ from the inlet (not shown).

Regardless, in the illustrated embodiments, once the resin/electrolyte suspension/slurry flows through, over, and/or around the wall of the cathode 16, the liquid enters the electroactive gap 20. When in the electroactive gap 20, chemical reactions take place in the liquid, which are driven by the electron flow supplied by the powered anode 18 and cathode 16. In this case, the chemical reactions are primarily reducing in nature (although oxidation reactions may also occur, these are favorably mitigated, controlled, and/or minimized as discussed variously throughout this disclosure). The liquid continues to flow between the anode wall 22 and the cathode 16 wall. Eventually, the liquid flows out of the electroactive gap 20, such that the treated liquid can be collected and/or otherwise directed for further treatment and/or use.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of concurrently electroreductively remediating poly- and perfluorinated alkyl substances (PFAS) and regenerating an ion-exchange resin material, the method comprising:
providing an electrolyte-containing spent ion-exchange resin slurry, the spent ion-exchange resin slurry comprising a plurality of PFAS molecules immobilized on a surface of an ion-exchange resin material in the electrolyte containing spent ion-exchange resin slurry; and
directing the electrolyte-containing, spent ion-exchange resin slurry through an electrochemical reduction reactor to remediate PFAS and form regenerated ion-exchange resin material in a regenerated ion-exchange material slurry.

2. The method of claim 1, further comprising forming the electrolyte-containing spent ion-exchange resin slurry by dispersing the spent ion-exchange resin material in an aqueous solvent.

3. The method of claim 2, wherein forming the electrolyte-containing spent ion-exchange resin slurry further comprises adding an electrolyte to the aqueous solvent.

4. The method of claim 1, further comprising capturing solid particles of the regenerated ion exchange resin material from the regenerated ion exchange resin slurry.

5. The method of claim 1, further comprising passing liquid remaining after removal of the solid particles of regenerated ion exchange resin material through an activated alumina bed to capture liberated fluoride ions.

6. The method of claim 1, wherein the electrolyte is chosen from one or more in the group of NaCl, NaOH, Na₂SO₄, K₂SO₄, KCl, KOH, NH₄Cl, NH₄OH, and (NH₄)₂SO₄.

7. The method of claim 1, wherein electrolyte-containing spent ion exchange resin slurry comprises the spent ion-exchange resin material in an amount of greater than about 0.5 weight percent, based on the weight of the electrolyte-containing spent ion exchange resin slurry.

8. The method of claim 1, wherein an anode of the electrochemical reduction reactor comprises elemental titanium metal, Magneli-phase titanium oxide, or a combination thereof.

9. The method of claim 1, wherein a cathode of the electrochemical reduction reactor comprises elemental titanium metal, Magneli-phase titanium oxide, boron doped diamond, mixed metal oxide, or any combination thereof.

10. The method of claim 1, further comprising adding an oxidant scavenger to the electrochemical reduction reactor.

11. The method of claim 10, wherein the oxidant scavenger comprises a reduced sulfur compound chosen from one or more in the group of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid.

12. The method of claim 1, wherein fluoride ions liberated from remediated PFAS are disposed of and the anion from the electrolyte displaces the PFAS headgroup remaining on the ion-exchange resin material.

13. The method of claim 1, wherein the ion exchange resin material comprises a strong base anion exchange resin, for example, such as Type I anion exchange resin or a Type II ion exchange resin.

14. An electroreductive and regenerative system comprising:
an electrochemical reduction reactor comprising a housing including a reactor inlet, an internal fluid flow-path, and a reactor outlet; a cathode having an outer, reducing, reactive surface disposed within the internal fluid flow-path; and an anode having an outer, oxidizing, reactive surface disposed within the internal fluid flow-path, at least portions of the anode outer, oxidizing, reactive surface and the cathode outer, reducing, reactive surface being separated by an electroactive gap, the internal fluid flow-path comprising the electroactive gap;
a power supply electrically connected to the anode and to the cathode such that electrons flow from the anode to the cathode; and
a spent ion-exchange resin slurry delivery inlet fluidly connected to the reactor inlet, the spent ion-exchange resin slurry delivery inlet being connected to a source of spent ion-exchange slurry.

15. The electroreductive and regenerative system of claim 14, further comprising an electrolyte inlet fluidly connected to the reactor inlet, the electrolyte inlet being connected to a source of electrolyte.

16. The electroreductive and regenerative system of claim 14, further comprising a solid liquid separator downstream of the reactor outlet, the solid liquid separator being configured to capture solid particles of regenerated ion exchange resin material that exit the reactor outlet.

17. The system of claim 14, wherein a voltage regulator is electrically coupled to the power supply, the voltage regulator controlling voltage of the power supply.

18. The system of claim 14, wherein a slurry container is fluidly connected to the spent ion exchange resin slurry delivery inlet, the slurry container being adapted to contain a spent ion slurry comprising spent ion resin material dispersed in a solvent containing an electrolyte.

19. The system of claim 14, further comprising an adsorbent fluidly connected to, and downstream of, the solid liquid separator, the adsorbent being configured to remove fluoride ions.

20. The system of claim 19, wherein the adsorbent comprises activated alumina.

21. The system of claim 14, wherein the electrolyte comprises a salt chosen from one or more in the group of NaCl, NaOH, Na₂SO₄, K₂SO₄, KCl, KOH, NH₄Cl, (NH₄)₂SO₄, and NH₄OH.

22. The system of claim 14, wherein the oxidizing, reactive, outer surface of the anode is elemental Titanium metal and the reducing, reactive, outer surface of the cathode is elemental titanium metal or Ti₄O₇.

23. The system of claim 14, further comprising an oxidant scavenger inlet fluidly connected to the reactor inlet, the oxidant scavenger inlet being connected to a source of oxidant scavenger.

24. The system of claim 23, wherein the source of oxidant scavenger comprises a reduced sulfur compound chosen from one or more of sulfur dioxide, sodium bisulfite, potassium bisulfite, calcium bisulfite, sodium metabisulfite, potassium metabisulfite, sodium thiosulfate, potassium thiosulfate, calcium thiosulfate, and ascorbic acid.

25. The system of claim 14, wherein the spent ion exchange resin material comprises a strong base anion exchange resin or a specialty ion exchange resin.

26. The system of claim 14, wherein the anode comprises a hollow cylinder coaxially located with the cathode, which is cylindrically-shaped, such that a longitudinal axis of the anode and a longitudinal axis of the cathode are substantially co-linear.
